(19) United States
(12) Patent Application Publication
(10) Pub. No.: US 2015/0266528 A1
(43) Pub. Date: Sep. 24, 2015

(54) TRAVELING BODY

(71) Applicant: DENSO CORPORATION, Kariya-city (JP)

(72) Inventors: Takenori MATSUE, Anjo-shi (JP); Koji KAWASAKI, Anjo-shi (JP)

(21) Appl. No.: 14/661,811

(22) Filed: Mar. 18, 2015

(30) Foreign Application Priority Data
Mar. 24, 2014 (JP) 2014-060399

(51) Int. Cl. B62D 61/10; B60B 19/00; B60G 17/016

(52) U.S. Cl. CPC B62D 61/10; B60G 17/016; B60B 19/003

(57) ABSTRACT

A traveling body has a plurality of legs, each of which displaces angularly around a joint shaft, a base part to which the plurality of legs are fixed, wheels that are respectively disposed at one end of the legs, and an actuator that changes an angle between the leg and the base part by rotating the joint shaft. The wheel has a plurality of omni wheels disposed rotatably on an outer periphery of the wheel, the small rotary members constituting parts of the wheel that contact the floor. Each omni wheel is disposed so that a rotation vector of the omni wheel intersects with both a rotation vector of the wheel and a rotation vector around the joint shaft.

### CROSS-REFERENCE TO RELATED APPLICATION

This application is based on and claims the benefit of priority from earlier Japanese Patent Application No. 2014-60399 filed Mar. 24, 2014, the description of which is incorporated herein by reference.

### TECHNICAL FIELD

The present disclosure relates to a traveling body.

### BACKGROUND

The Japanese Patent Application Laid-Open Publication No. 2010-76630 discloses a traveling body having a truck body, four legs pivotally attached to the truck body via joint shafts which support the truck body to an arbitrary height relative to a floor, and wheel portions disposed at ends of the legs that contact with the floor.

Furthermore, the traveling body has a leg joint shaft actuator for changing an angle between the leg and the floor by rotating a joint shaft of the leg, and a plurality of omni wheels disposed rotatably around the wheel portion.

A rotation vector around the joint shaft of the leg is provided so as to be substantially parallel to a rotation vector of the omni wheel that is grounded on the floor.

According to the Publication No. '630, as shown in FIG. 1 of the Publication, low center of gravity and a highly stable traveling are implemented by controlling the angle of the legs by rotating the leg joint shaft of the leg so as to greatly expand the legs as viewed from the side.

On the other hand, for the traveling body to travel along a narrow passage or the like, it is necessary to reduce a footprint area formed by connecting grounding points of the floor and the wheel portions.

Therefore, in the traveling body of the Publication No. '630, the legs are rotated around the leg joint shafts so that the legs to approach perpendicularly to the floor.

According to this pose, the position of the truck body from the floor becomes high, and thus the center of gravity position becomes high.

Therefore, it means that the traveling stability is inhibited, and it is impossible to travel in a lower area such that overhead obstacles exist.

### SUMMARY

An embodiment provides a traveling body that can obtain a stable traveling pose with reduced body height and is able to travel even in a narrow passage.

In a traveling body according to a first aspect, the traveling body includes a plurality of legs, each of which has a joint shaft and displaces angularly around the joint shaft, a base part to which the plurality of legs are fixed so as to extend downwardly, wheels that are respectively disposed at one end of the legs, a plurality of small rotary members disposed rotatably on an outer periphery of the wheel, the small rotary members constituting parts of the wheel that contact the floor, and a rotary driving device that changes an angle between the leg and the base part by rotating the joint shaft. The small rotary member is disposed so that a rotation vector of the small rotary member intersects with both a rotation vector of the wheel and a rotation vector around the joint shaft.

According to the present disclosure, the rotation vector of the small rotary member is configured so as to intersect with both the rotation vector of the wheel and the rotation vector around the joint shaft.

According to the present configuration, a movement track of the wheel when the leg is displaced angularly is not parallel with, but intersects relative to a direction extended radially outward from the center of the base part when the joint shaft is driven to rotate.

That is, the angle between the base part and the leg does not become a large obtuse angle when the leg is displaced angularly, and a stable traveling pose can be realized.

Therefore, according to the present structure, since the leg can be displaced angularly so that the wheel does not spread largely radially outward from the center of the base part, reduction of a footprint area formed by connecting the floor and the grounding point of each wheel can be realized.

Further, according to the present configuration, since it is possible to travel reducing the footprint area even when the angle between the leg and the base part is not 90 degrees, it is possible to travel in a pose where a height from the floor to the base part is reduced.

From the above, in the present disclosure, the traveling body that can obtain a stable traveling pose with reduced body height and is able to travel even in a narrow passage can be provided.

### BRIEF DESCRIPTION OF THE DRAWINGS

In the accompanying drawings:

FIG. 1 shows a front view of a traveling body for describing a structure thereof in a first embodiment to which the present disclosure is applied;

FIG. 2 shows a bottom view of the traveling body for describing the structure thereof in the first embodiment;

FIG. 3 shows a front view of a leg module of the traveling body for describing the structure thereof in the first embodiment;

FIG. 4 shows a bottom view of the leg module for describing the structure thereof;

FIG. 5 shows a block diagram relating to a control of the traveling body of the present disclosure;

FIG. 6 shows a diagram for describing a movement and a rotational speed of a wheel in the traveling body;

FIG. 7 shows a front view of a traveling body for describing a structure thereof in a second embodiment to which the present disclosure is applied;

FIG. 8 shows a bottom view of the traveling body for describing the structure thereof in the second embodiment;

FIG. 9 shows a front view of a traveling body showing a condition in which a footprint area is made smaller in a third embodiment to which the present disclosure is applied;

FIG. 10 shows a top view of the traveling body showing the same condition as FIG. 9;

FIG. 11 shows a front view of the traveling body showing a condition in which the footprint area is made larger in the third embodiment; FIG. 12 shows a top view of the traveling body showing the same condition as FIG. 11;

FIG. 13 shows a diagram of the traveling body for describing changes during turning clockwise in the third embodiment; and

FIG. 14 shows a diagram of the traveling body for describing changes during turning counterclockwise in the third embodiment.

### DETAILED DESCRIPTION OF THE PREFERABLE EMBODIMENT

Several embodiments of the present disclosure will be described in the following with reference to the accompanying drawings.

It should be appreciated that, in the embodiments, components identical with or similar to those in an antecedent embodiment are given the same reference numerals, and structures and features thereof will not be described in order to avoid redundant explanation.

In addition, when only a part of the configuration is explained in each embodiment, other forms as described antecedently can be applied to other parts of the configuration.

Further, unless problems occur in the combination in particular, not only a combination of parts to each other that is specified as a possible combination in the embodiments is possible, but it is also possible to combine embodiments together partially even if not expressed clearly.

### First Embodiment

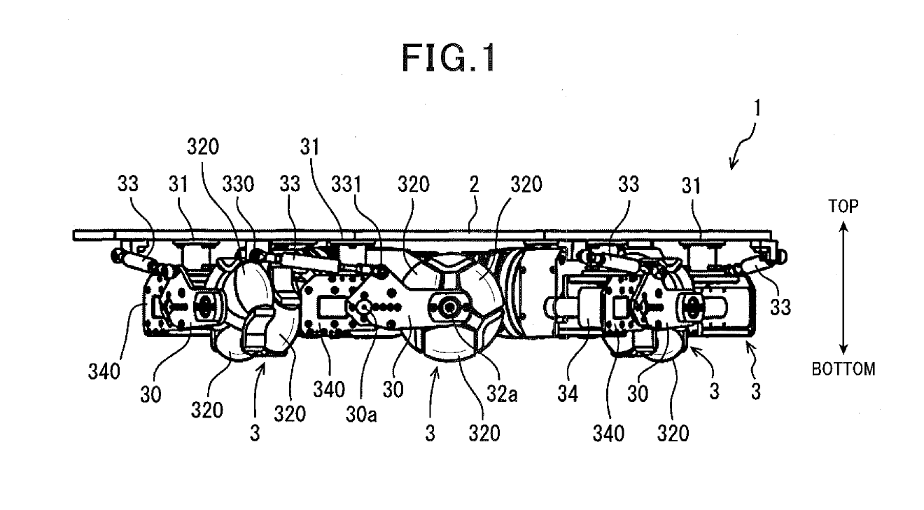

A traveling body 1 according to the first embodiment of the present disclosure will be described with reference to FIGS. 1-6.

The traveling body 1 performs a predetermined operation by using various command signals sent from a controller 60, etc. and information obtained by various sensors, for example, and enables a proper traveling by an actuation of each drive unit being controlled according to a control signal based on a calculated result.

The traveling body 1 has a specific configuration in order to allow traveling through a particularly narrow passage, or a place where overhead head height is low. The traveling body 1 may be applied to remote-controlled toys, agricultural machines, search robots, load transportation robots, human transportation robots or the like, for example.

The traveling body 1 has a receiver for receiving a radio wave from a transmitter such as a controller 60, a control unit 50 for generating control signals, wheel motor 35, a driver such as an actuator 34 for a leg joint, and a battery for driving the receiver and the control unit 50.

The traveling body 1 has a plurality of legs 30, a base part 2 to which the plurality of legs 30 are fixed so as to extend downwardly, and wheels 32 that are respectively disposed at one end of the legs 30.

Further, the battery that the traveling body 1 has is a secondary battery such as a nickel-hydrogen battery, a lithium ion battery, or the like, for example.

The battery can be charged with electric power supplied from the outside, and can discharge the stored power, for example.

An actuator 34 is a rotary driving device for changing an angle between the leg 30 and the base part 2 by rotating a joint shaft 30a of the leg 30, and is constituted by a servo motor, for example.

A wheel motor 35 is a rotary driving device for rotating a rotating shaft 32a of the wheel 32.

The traveling body 1 may have a configuration including the receiver in the control unit 50, or may be configured to include the receiver as a device for inputting a signal to the control unit 50.

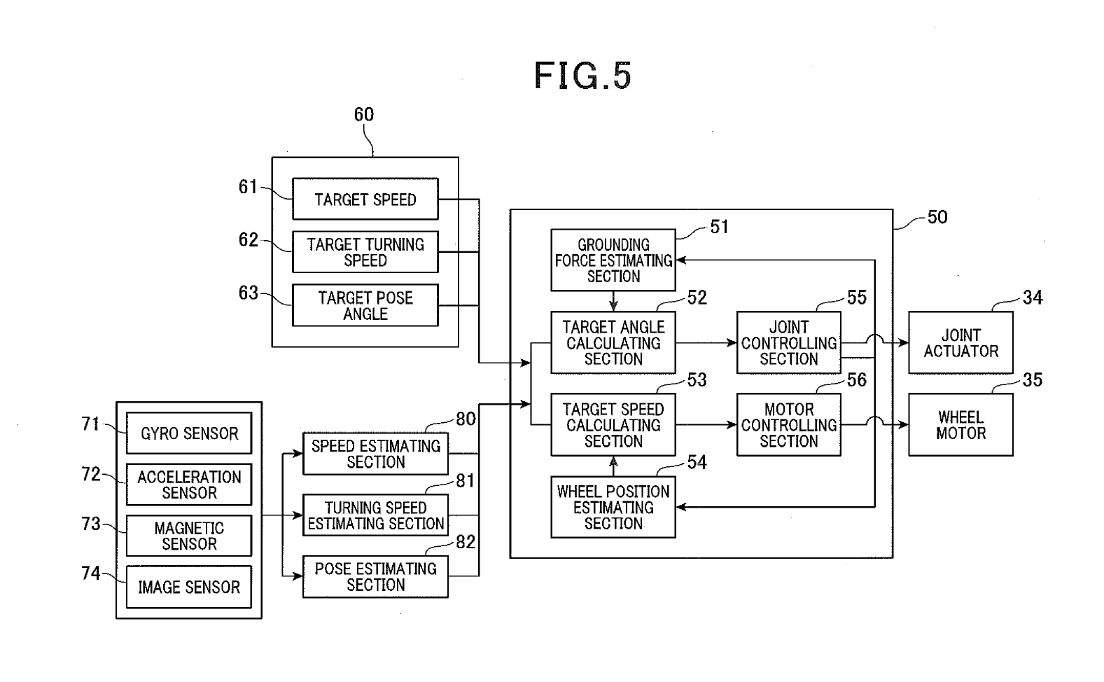

As shown in FIG. 5, the receiver receives various signals generated based on a calculation command generated by a calculation of the controller 60, such as a lo target speed signal 61, a target turning speed signal 62, and a target pose angle signal 63, for example.

The receiver receives each estimated value estimated in a speed estimating section 80, a turning speed estimating section 81, and a pose estimating section 82. Each estimated value is generated in each section through a calculation of a predetermined program using various data related to a position information and the like obtained by a condition detector 70, which will be described later.

The condition detector 70 is a means for detecting a condition of the traveling body 1, and is configured including a gyro sensor 71, an acceleration sensor 72, a magnetic sensor 73, an image sensor 74 and the like that are provided in the traveling body 1.

The condition detector 70 is configured including at least the gyro sensor 71 and the acceleration sensor 72.

The gyro sensor 71 detects how many times the traveling body 1 is rotating per second relative to a reference axis, for example.

The acceleration sensor 72 detects an acceleration of the sensor itself; a change in speed per one second, for example.

The acceleration sensor 72 can also detects a movement of the traveling body 1 or a vibration of the traveling body 1 by detecting an acceleration of the traveling body 1 in a gravity direction, i.e., a gravitational acceleration.

Further, if the acceleration sensor 72 is a three-axis acceleration sensor, it is also possible to detect a horizontal pose of the traveling body 1.

The magnetic sensor 73 detects an absolute direction of the traveling body 1.

The image sensor 74 can detect a movable direction and a movable amount of the traveling body 1, for example, by analyzing surrounding images including a floor or the like acquired by a camera.

The speed estimating section 80 estimates a speed of the traveling body 1 by performing a predetermined calculation using detected values from the acceleration sensor 72.

The turning speed estimating section 81 estimates a turning speed of the base part 2 by performing a predetermined calculation using detected values from the gyro sensor 71 and the acceleration sensor 72.

The pose estimating section 82 estimates a pose of the traveling body 1 by performing a predetermined calculation using the detected values from the acceleration sensor 72 and the gyro sensor 71, and the pose of the traveling body 1, i.e., a rotational angle of roll around an X-axis, a rotational angle of pitch around a Y-axis, and a rotational angle of yaw around the Z-axis, for example. The control unit 50 has a grounding force estimating section 51, a target angle calculating section 52, a target speed calculating section 53, a wheel position estimating section 54, a joint controlling section 55, and a motor controlling section 56.

The control unit 50 calculates a target angle of the leg section 30 and a target rotational speed of the wheel 32 by a predetermined calculation using estimated values of the speed, the turning speed, and the pose inputted to the control unit 50.

The target angle calculating section 52 generates the target angle of the leg 30 required to achieve the target rotational speed and the target pose angle.

The target rotational speed calculating section 53 generates the target rotational speed of the wheel 32 required to achieve the target rotational speed and the target speed.

The joint controlling section 55 controls a rotational position of the actuator 34 for the leg joint by a drive control signal based on the generated target angle.

The motor controlling section 56 controls the rotational speed of the wheel motor 35 by the drive control signal based on the generated target speed.

The actuator 34 controls the joint shaft 30a of the leg 30 to the target angle corresponding to the drive control signal from the joint controlling section 55.

The wheel motor 35 controls the rotating shaft 32a of the wheel 32 to the target rotational speed corresponding to the control driving signal from the motor control unit 56.

The joint controlling section 55 transmits the information for controlling the actuator 34 to the grounding force estimating section 51 and the wheel position estimating section 54.

The grounding force estimating section 51 estimates the grounding force from the floor that each of omni wheel 320, which is disposed in the wheel 32, receives.

The wheel position estimating section 54 estimates the position of the wheel 32 and a translational moving amount.

The grounding force estimating section 51 calculates the torque based on a current value flowing to the servo motor, which is an example of an actuator 34, inputted from the joint controlling section 55.

The grounding force estimation unit 51 obtains the angle of each leg 30 from the calculated value of the torque, and estimates the current grounding force of each wheel from the angle.

The target angle calculating section 52 calculates the target angle of each leg 30 (also referred to as a target angular speed) based on drag values from the floor that is estimated by the grounding force estimating section 51.

For example, the target angle calculating section 52 calculates and adjusts the target angle to put the traveling body 1 in a stable condition when the estimated grounding force estimated value is determined to be small.

In this way, the target angle is re-set by using the data obtained from the joint controlling section 55, and the angle of each leg 30 is feedback controlled.

The wheel position estimating section 54 calculates the torque from the current value of the servo motor, obtains the angle of each leg 30 from the calculated value of the torque, and estimates the current position and a target speed direction of each wheel from the angle.

The target rotational speed calculating section 53 calculates a target speed of each wheel 32 based on the current estimated position and the estimated target speed direction of each wheel.

In this way, the target rotational speed is re-set by using the data obtained from the motor controlling section 56, and the rotational speed of the wheel 32 is feedback controlled.

Further, the target speed signal 61, the target turning speed signal 62, and the target pose angle signal 63 may be configured to be generated in the control unit 50 based on the calculation command inputted from the controller 60.

Furthermore, the speed estimating section 80, the turning speed estimating section 81, and the pose estimating section 82 may be configured to be included in the control unit 50.

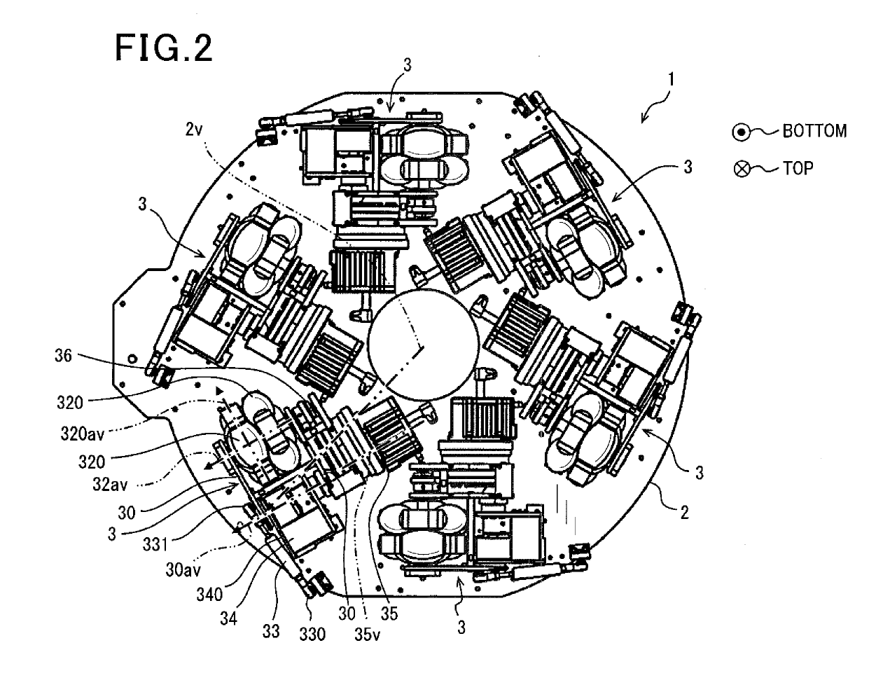

As shown in FIG. 2, the traveling body 1 is provided with six leg modules 3 that are fixed to an under surface of the base part 2.

The six leg modules 3 are disposed on the under surface of the base part 2 so as to be disposed annularly.

Each leg module 3 is fixed to the base part 2 in a pose of arranging the wheel motor 35 toward the center of the base part 2 and the wheel 32 to near an outer peripheral edge of the base part 2.

Each leg module 3 is disposed so as to extend downwardly from the under surface of the base part 2 by fixing the main fixing part 31 and a first end side fixing portion 330 of the spring member 33 to the base part 2.

The leg 30 has the joint shaft 30a, and angularly displaces around the joint shaft 30a.

The wheel 32 is provided at a tip of each leg 30.

The wheel 32 has the omni wheels 320 that are a plurality of small rotary members disposed rotatably on an outer periphery of the wheel 32, and the omni wheels 320 constitute portions to come in contact with the floor in the wheel 32.

As shown in FIGS. 2-44, the leg module 3 has the leg 30 made of two plate members, the wheel 32, the actuator 34, the wheel motor 35, a gearbox 36, and the spring member 33.

The wheel 32 is formed by an inner wheel positioned closer to the center of the base part 2 and an outer wheel.

Three omni wheels 320 are provided to each of the inner wheel and the outer wheel so as to align annularly.

Thus, each of the inner wheel and the outer wheel is composed of a supporting body, three omni wheels 320, and the single rotating shaft 32a.

The three omni wheels 320 and the supporting body, which rotatably supports rotation shafts 320a of the omni wheel 320 between the adjoining omni wheels 320, are formed integrally to form a shape of a tire, and constitute each of the inner wheel and the outer wheel.

The supporting body constitutes bearing portions for rotatably supporting both ends of the rotating shaft 320a.

A through hole is formed in a central part of the supporting body, and the rotating shaft 32a is inserted in the through hole and fixed.

The three omni wheels 320 and the supporting body are rotated integrally around the rotating shafts 32a of the wheel 32 by the driving force of the wheel motor 35 via a plurality of stages of reduction gears.

Therefore, the inner wheel and the outer wheel are rotated coaxially around the rotating shaft 32a.

Further, rotating directions of the inner wheel and the outer wheel are variable by changing a rotating direction of the wheel motor 35.

In the wheel 32 that is configured in this manner, when the rotational force is applied, the wheel 32 becomes movable in the rotational direction by friction force between the omni wheel 320 and a ground plane.

On the other hand, when a moving force acts to a direction parallel to the rotating shaft 32a, each of the omni wheels 320 becomes idle state so that it is possible to smoothly move to the direction along the rotation shaft 32a.

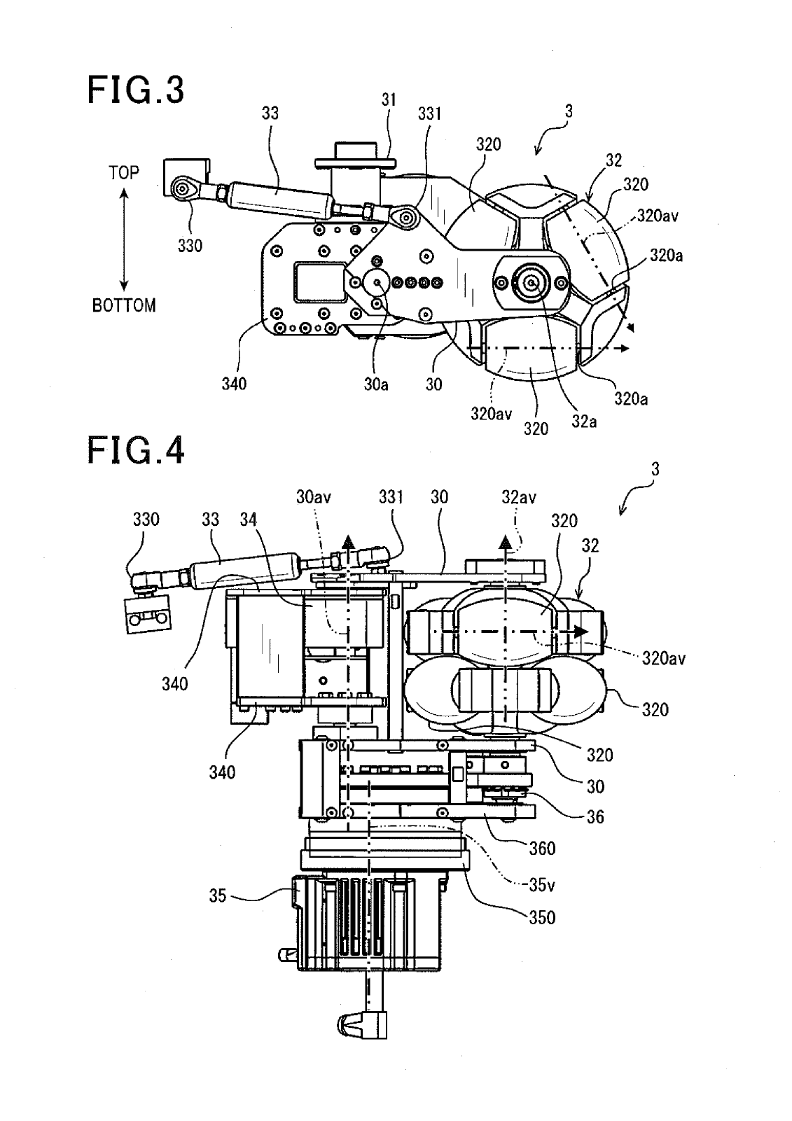

As shown in FIG. 3, the spring member 33 has the first end side fixing portion 330 fixed to the base part 2 and a second end side fixing portion 331 fixed to the leg 30 to support the leg 30.

The spring member 33 supports the leg 30 parallel relative to the base part 2 by its spring force.

Even when a heavy load is put on the base part 2, it is possible to hold down the driving force of the driver by the function of the spring member 33.

A condition shown in FIG. 3 is a condition where an angle between the base part 2 and the leg 30 is zero or close to zero so that the pose of the leg module 3 is the lowest, thus the height of the traveling body 1 is in the lowest state.

The legs 30 is supported to the traveling body 1 by the joint shaft 30a, and rotates downwardly around the joint shaft 30a by the rotation driving force of the actuator 34.

Therefore, the leg 30 is stationary when the spring force of the spring member 33 and the torque of the actuator 34 are balanced, and is a movable portion that can change the angle between the base part 2.

As shown in FIGS. 2 and 4, one end of the leg 30 is rotatably supported around the joint shaft 30a, while another end of the leg 30 rotatably supports the rotating shafts 32a of the wheel 32.

The other end of the leg 30 constitutes a bearing portion for rotatably supporting the rotating shaft 32a.

Furthermore, the leg 30 made of two plate members is disposed so as to support the rotating shaft 32a from both sides of the wheel 32.

The actuator 34 is disposed adjacent to the wheel 32 in the joint shaft 30a side.

The actuator 34 is supported by a holder 340 that is fixed to the traveling body 1.

The gear box 36 has a plurality of stages of speed reduction gears therein, and is supported by a holder 360 at a position closer to the center of the base part 2 than the wheel 32.

The wheel motor 35 is supported by a holder 350 at a position closer to the center of the base part 2 than the wheel 32 or the gear box 36 is.

At least the actuator 34 and the wheel motor 35 are stationary devices that do not move in the traveling body 1.

The traveling body 1 has the following peculiar structure.

As shown in FIG. 2, a plurality of leg modules 3 disposed in the traveling body 1 is mounted to fit inside the outer peripheral edge of the base part 2.

Furthermore, the leg modules 3 are mounted on the under surface of the base part 2 so as the legs 30 and the wheels 32 do not protrude outwardly from the outer peripheral edge of the base part 2 even when the angle between the leg 30 and the base part 2 increases by changing from the state shown in FIG. 3 depending on the driving conditions.

Moreover, the plurality of leg modules 3 are disposed on the under surface of the base part 2 so as to align annularly.

As shown in FIG. 2, the plurality of leg modules 3 disposed on the base part 2 annularly form a predetermined space around the center of the under surface of the base part 2.

The battery, the motor and the like may be disposed in the predetermined space.

Each omni wheel 320 is disposed so that a rotation vector 320av around the rotation axis 320a of the omni wheel 320 crosses both a rotation vector 32av around the rotating shafts 32a of the wheel 32 and a rotation vector 30av around the joint shaft 30a of the leg 30.

Here, the rotation vector 320av is a vector in a direction along a central axis (corresponding to the rotation axis 320a) when the omni wheel 320 rotates.

Further, the rotation vector 32av is a vector in a direction along a central axis (corresponding to the rotating shaft 32a) when the wheel 32 rotates.

Furthermore, the rotation vector 30av is a vector in a direction along a central axis (corresponding to the joint shaft 30a) when the leg 30 rotates.

Preferably, the omni wheel 320 is disposed in the traveling body 1 so that the rotation vector 320av is perpendicular to the rotation vector 30av.

Furthermore, the leg 30 is disposed so the rotation vector 30av to be oriented along the rotation vector 32av.

That is, the rotation vector 32av and the rotation vector 30av are set in a direction extending parallel or substantially parallel.

Moreover, as shown in FIGS. 2 and 4, an axis vector 35v extending along the axis of the wheel motor 35 is a direction along both the rotation vector 30av and the rotation vector 32av.

The axis vector 35v is a vector having a direction along the rotation axis of the wheel motor 35.

With the present configuration, the wheel motor 35 that is positioned closer to the center of the base part 2 than the wheel 32 is disposed in the leg modules 3 so that the axial vector 35v and the joint shaft 30a are substantially coaxial.

Moreover, the wheel motor 35 is disposed in the leg modules 3 so that the axis vector 35v and joint shaft 30a intersect perpendicularly.

Further, in the traveling body 1, the rotation vector 32av and the rotation vector 30av are configured not parallel to, but to cross a radius vector 2v extending radially outward from the center of the base part 2.

That is, the leg module 3 is fixed to the base part 2 so as to be an inclined pose with respect to the radius vector 2v.

In other words, the axis vector 35v of the wheel motor 35 and the radius vector 2v have a relationship such that the vectors intersect.

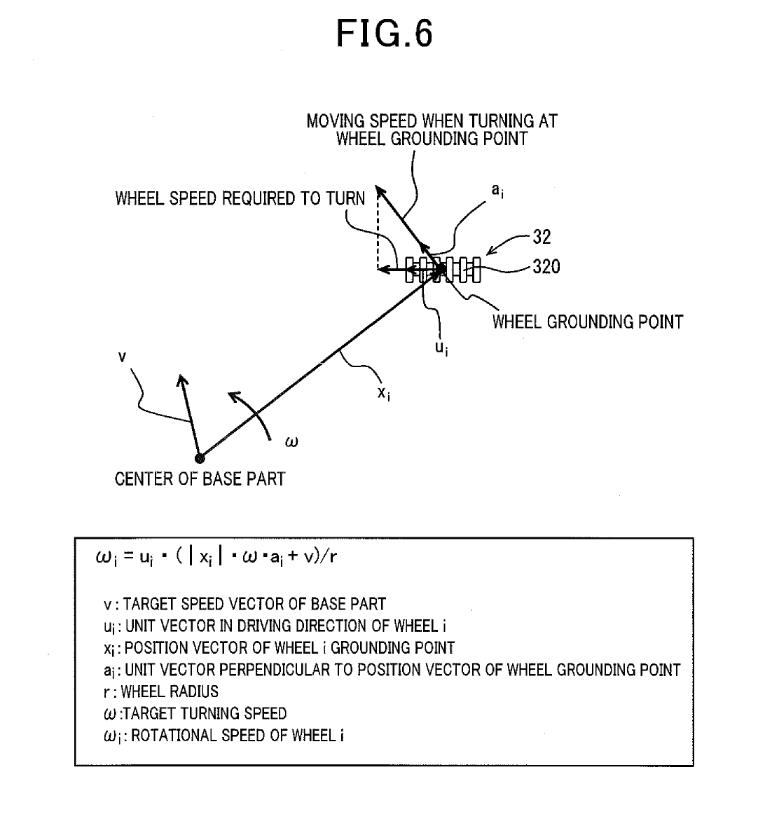

Next, referring to FIG. 6, a method for determining the rotational speed (target speed) of the wheel 32 required to move and turn is described.

A target speed vector v of the base part 2, a position vector xᵢ of the wheel i (i is 1-6) from the center of the base part 2, a unit vector aᵢ perpendicular to the position vector xᵢ, and a unit vector uᵢ in a driving direction of the wheel i shown in FIG. 6 are obtained by using detected values and the like of the condition detector 70.

The unit vector aᵢ is the same direction as a vector of a moving speed when turning at a wheel grounding point.

The unit vector uᵢ is the same direction as the wheel speed of a vector required to turn.

The radius of the wheel is a fixed value r.

The target turning speed is denoted by ω.

The rotational speed (target speed) ωᵢ of the wheel i can be calculated by the following Equation 1 using these data.

ωᵢ=uᵢ·(|xᵢ

|·aᵢ+v)/r

For example, the target speed calculating section 53 generates a required target rotational speed cui of the wheel 32 by a calculation based on the Equation 1.

Next, function and effect that the traveling body brings will be described.

The traveling body 1 has the plurality of legs 30 that respectively displace angularly around the joint shaft 30a, the base part 2 to which the plurality of legs 30 are fixed, the wheel 32 provided at the end of each leg 30, and the actuator 34 that varies the angle between the leg 30 and the base part 2 by rotating the joint shaft 30a.

The wheel 32 has the plurality of omni wheels 320 that constitute the portions in contact with the floor in the wheel 32, and the omni wheels 320 are rotatably disposed on the outer periphery of the wheel 32.

Each omni wheel 320 is disposed so that the rotation vector 320av around the rotation axis 320a of the omni wheel 320 crosses both the rotation vector 32av around the rotating shafts 32a of the wheel 32 and the rotation vector 30av around the joint shaft 30a of the leg 30.

According to the present configuration, the rotation vector 320av of the omni wheel 320 is configured so as to intersect with both the rotation vector 32av of the wheel 32 and the rotation vector 30av around the joint shaft 30a.

According to the present configuration, a movement track of the wheel 32 when the leg 30 is displaced angularly is not parallel with, but intersects relative to a direction extended radially outward from the center of the base part 2 when the joint shaft 30a is driven to rotate.

In other words, even if the traveling body 1 is controlled so that the angle between the base part 2 and the leg 30 does not become a large obtuse angle when the leg 30 is displaced angularly, a stable traveling pose can be realized.

Therefore, according to the present configuration, the leg 30 can be displaced angularly so as the wheel 32 not to greatly spread radially outward from the center of the base part 2.

Thus, the traveling body 1 can realize to reduce a footprint area formed by connecting the floor and the grounding point of each wheel 32.

Further, according to the present configuration, since it is possible to travel reducing the footprint area even when the angle between the leg 30 and the base part 2 is not 90 degrees, it is possible to travel in a pose where a height from the floor to the base part 2 is reduced.

Accordingly, the traveling body 1 realizes a stable traveling pose with reduced body height, and allows traveling in a narrow passage, or the like.

In addition, the rotation vector 320av of the omni wheel 320 preferably intersects perpendicularly with respect to the rotation vector 30av around the joint shaft 30a.

According to the present configuration, the movement track of the wheel 32 when the leg 30 is displaced angularly is not parallel with, but intersects relative to the direction extended radially outward from the center of the base part 2 when the joint shaft 30a is driven to rotate.

Therefore, according to the present configuration, the leg 30 can be displaced angularly so as the wheel 32 not to spread in a direction protruding from the outer peripheral edge of the base part 2.

Thus, the traveling body 1 can realize further reduction of the footprint area formed by connecting the floor and the grounding point of each wheel 32. Further, the rotation vector 30av around the joint shaft 30a is the direction along the rotation vector 32av around the rotating shafts 32a of the wheel 32.

According to the present configuration, the traveling body 1 that can achieve both grounding the wheel 32 stably and suppressing the size of the footprint area when the legs 30 is displaced angularly can be provided.

The traveling body 1 has the leg modules 3 constituted at least by the legs 30, the wheels 32, the actuators 34, and the wheel motors 35.

The leg module 3 is provided with the wheel motor 35 so that the leg 30 and the rotation axis of the wheel motor 35 intersect perpendicularly.

According to the present configuration, in the leg module 3 where the leg 30 and wheel 32, and the wheel motor 35 are disposed in line, the wheel motor 35 that is not moving can be positioned toward the center of the base part 2, while the movable legs 30 and the wheels 32 can be positioned on the outer peripheral edge of the base part 2.

Accordingly, the traveling body 1 that effectively utilizes the space of the under surface side of the base part 2 for mounting a plurality of leg modules 3 can be provided.

Furthermore, the wheel motors 35 are positioned closer to the center of the base part 2 than the wheels 32 are.

The rotation axis of the wheel motor 35 and the joint shaft 30a are configured to be substantially coaxial.

According to the present configuration, even when the legs 30 are displaced angularly, the legs 30 and the wheels 32 can be displaced without being affected by the position of the wheel motor 35.

Further, according to the present configuration, by disposing the motor having large inertia near a root of the leg 30, it is possible to reduce the load.

In addition, the rotation vector 30av around the joint shaft 30a and the rotation vector 320av of the omni wheel 320 are configured not parallel to, but to cross the radius vector 2v extending radially outward from the center of the base part 2.

According to the present configuration, it is possible to dispose the leg modules 3 that effectively use the space under the base part 2, and it is possible to reduce an outer diameter of the base part 2.

Further, the leg modules 3 are disposed on the base part 2 so as the legs 30 and the wheels 32 do not protrude outwardly from the outer peripheral edge of the base part 2 even when the angle between the leg 30 and the base part 2 changes.

According to the present configuration, whatever the traveling condition, the legs 30 and the wheels 32 do not protrude outwardly from the outer peripheral edge of the base part 2 in the traveling body 1.

Thus, regardless of the rotational angle of the legs 30, it is possible to provide the traveling body 1 that can travel a traveling path as long as the base part 2 can pass.

Moreover, the plurality of leg modules 3 are mounted on the base part 2 so as the legs 30, the wheels 32, and the joint shaft 30a are positioned along the outer peripheral edge of the base part 2.

According to the traveling body 1 of the present configuration, it is possible to increase the size of the footprint area, and it is possible to provide a more stable traveling pose.

### Second Embodiment

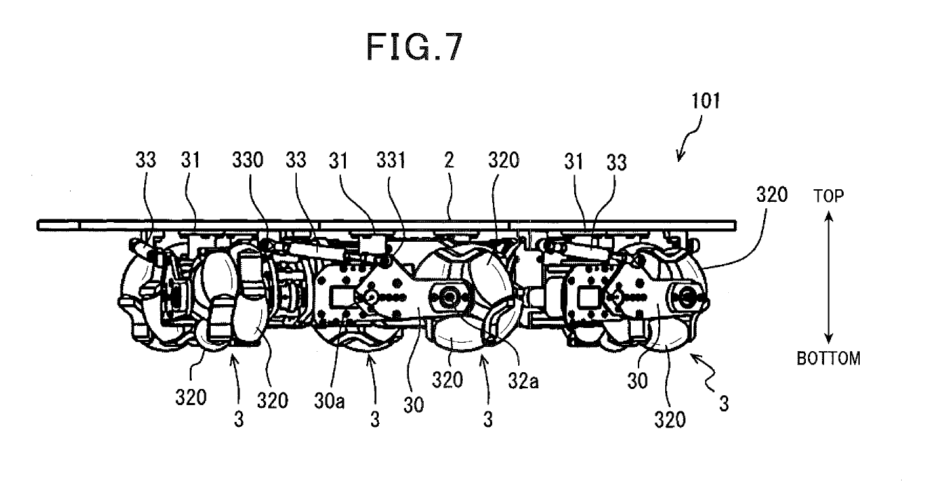

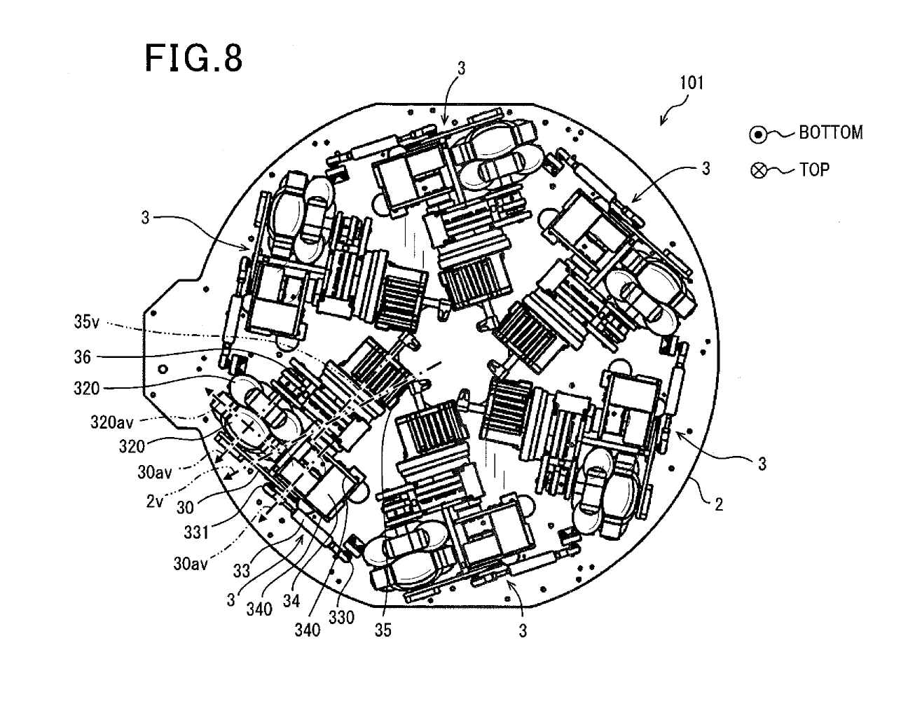

In the second embodiment, a traveling body 101 which is another aspect of the traveling body 1 of the first embodiment will be described with reference to FIGS. 7 and 8.

In FIGS. 7 and 8, components identical with or similar to those in the first embodiment are given the same reference numerals, and achieve the same function and effect.

Configurations, functions and effects not particularly described in the second embodiment are similar to those of the first embodiment.

Hereinafter, only different points from the first embodiment will be described.

In addition, those having the same configuration as the first embodiment in the second embodiment are assumed to achieve the same function and effect described in the first embodiment.

As shown in FIG. 8, in the traveling body 101, the rotation vector 32av and the rotation vector 30av are configured not parallel to, but to cross the radius vector 2v.

That is, the leg module 3 is fixed to the base part 2 so as to be an inclined pose with respect to the radius vector 2v.

Furthermore, the traveling body 101 is configured such that a part of each leg module 3 in the center of the base part 2 side, the wheel motor 35, for example, is positioned nearer to the center of the base part 2 as compared with the traveling body 1.

According to the traveling body 101 of the second embodiment, it is possible to reduce the size of the base part 2 where the plurality of leg modules 3 is mounted.

Therefore, the size of the traveling body 101 is more reduced, and it is possible to provide the traveling body 101 that can travel even in a narrower passage, or the like.

### Third Embodiment

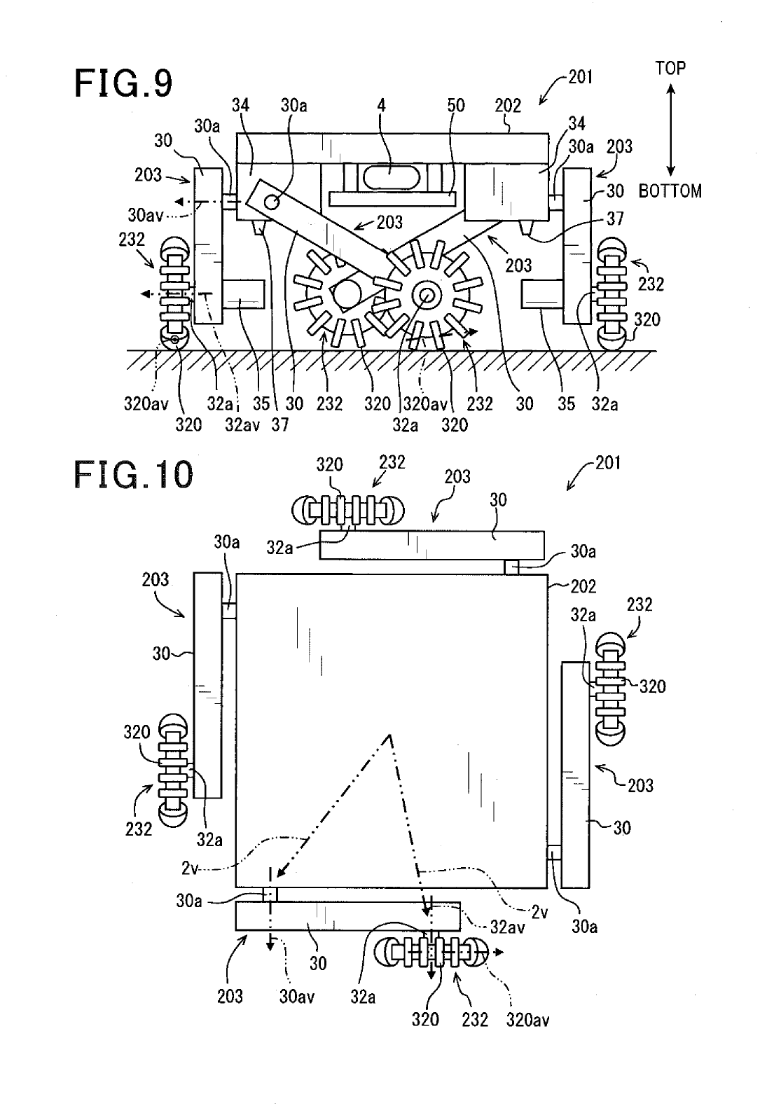

In the third embodiment, a traveling body 201 which is another aspect of the traveling body 1 of the first embodiment will be described with reference to FIGS. 9-14.

In FIGS. 9-14, components identical with or similar to those in the first embodiment are given the same reference numerals, and achieve the same function and effect.

Configurations, functions and effects not particularly described in the third embodiment are similar to those of the first embodiment.

Hereinafter, only different points from the first embodiment will be described.

In addition, those having the same configuration as the first embodiment in the third embodiment are assumed to achieve the same function and effect described in the first embodiment.

As shown in FIGS. 9-12, the traveling body 201 has four leg modules 203.

Each leg module 203 is disposed to a base part 202, which is a rectangular plate-like member, so as the leg 30 extends along a side surface of the base part 202.

In addition, a wheel 232 disposed at an end of each leg module 203 is also disposed extending along the side surface of the base part 202.

The wheel 232 has omni wheels 320 that are a plurality of small rotary members disposed rotatably on an outer periphery of the wheel 232, and the omni wheels 320 constitute portions to come in contact with the floor in the wheel 232.

The leg 30 is attached to the base part 202 via the actuator 34 to which the joint shaft 30a is connected.

The actuators 34 are fixed to four corners of the base part 202 on the under surface.

The joint shaft 30a extends so as to project from the actuator 34 to the side.

The battery 4 and the control unit 50 are mounted on the under surface of the central portion of the base part 202.

The traveling body 201 has landing legs 37 projecting downwardly at the bottom of each actuator 34.

Therefore, the four landing legs 37 project downwardly from back sides of the four corners of the base part 202.

For example, the traveling body 201 may control the angle of the leg 30 so as to allow the landing legs 37 to land on the floor and the wheels 232 away from the floor.

According to this, it is possible to suppress the wear of a tire of the wheel 232, or to suppress the power consumption for holding the pose by taking a loosen pose.

The traveling body 201 can carry out calibrations of various sensors described above in a condition where the landing legs 37 are in contact with the floor.

In addition, the traveling body 201 is capable of measuring a weight and a center of gravity of a load loaded on the base part 202 by providing a load sensor on the under surface of the landing legs 37, and thus management of load to be transported can be carried out.

Each rotation vector shown satisfies the same configuration, the relationship, and the effect as the rotation vector denoted by the same reference numerals in the first embodiment.

FIGS. 9 and 10 show a state in which the footprint area of the traveling body 201 is small by reducing the angle between the leg 30 and the base part 202 (for example, an acute angle less than 90 degrees) by folding the legs 30.

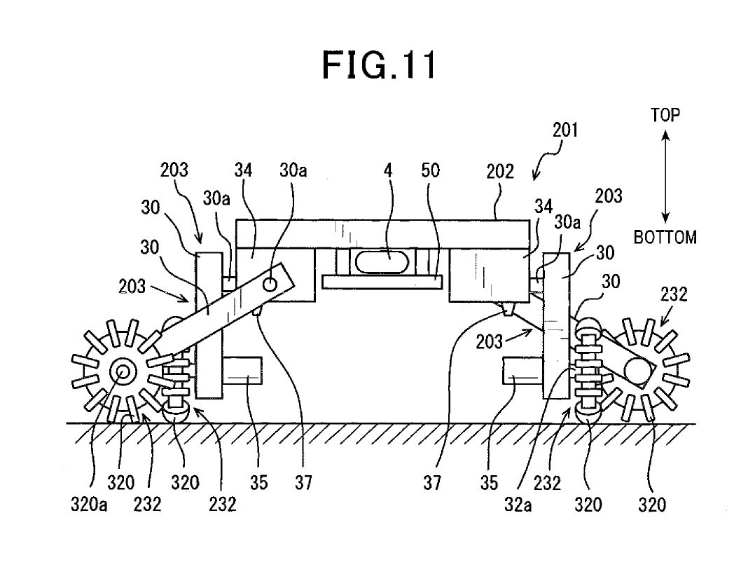

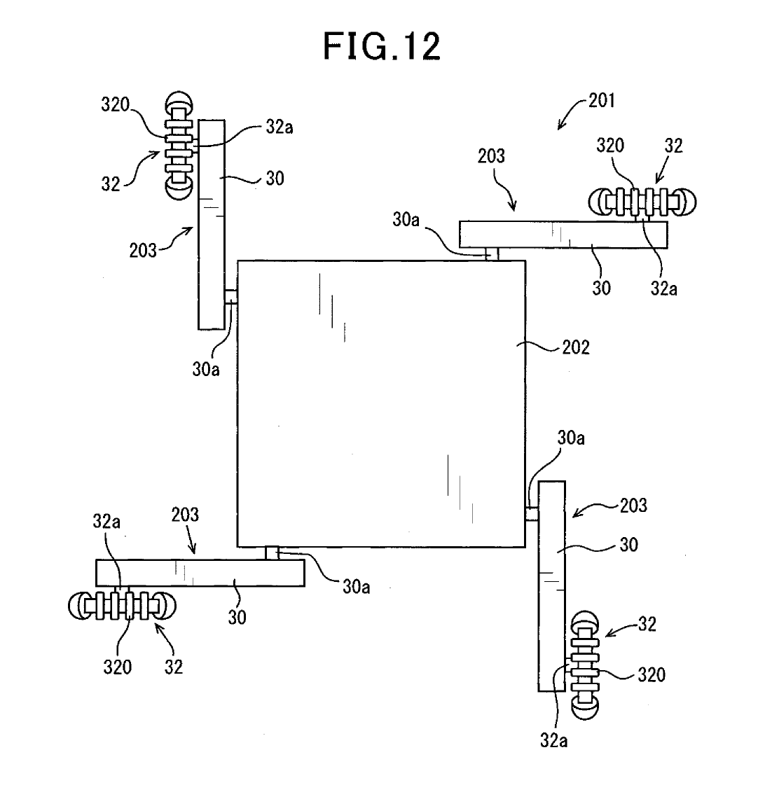

FIGS. 11 and 12 show a state in which the footprint area of the traveling body 201 is made large by increasing the angle between the leg 30 and the base part 202 (for example, an obtuse angle more than 90 degrees) by expanding the legs 30 outwardly.

The traveling body 201 travels in a pose shown in FIGS. 9 and 10 in a condition where a traveling passage is narrow, and travels in a pose shown in FIGS. 11 and 12 by changing the orientation of the legs 30 in a condition where the traveling passage is wide and a stability is required.

Although the size of the footprint area is greatly changed in the condition shown in FIGS. 9 and 10, and in the condition shown in FIGS. 11 and 12, there is not much change in the height of the base part 202, i.e., the body height of the traveling body 201.

Thus, there is no difference in terms of the passage height limit for traveling in either condition where the footprint area is large or small in the traveling body 201.

Further, in the traveling body 201, it is possible to overcome a step or the like by putting the legs 30 or wheels 232 on the step or the like by rotating to lift any of the legs 30 among the four leg modules 203.

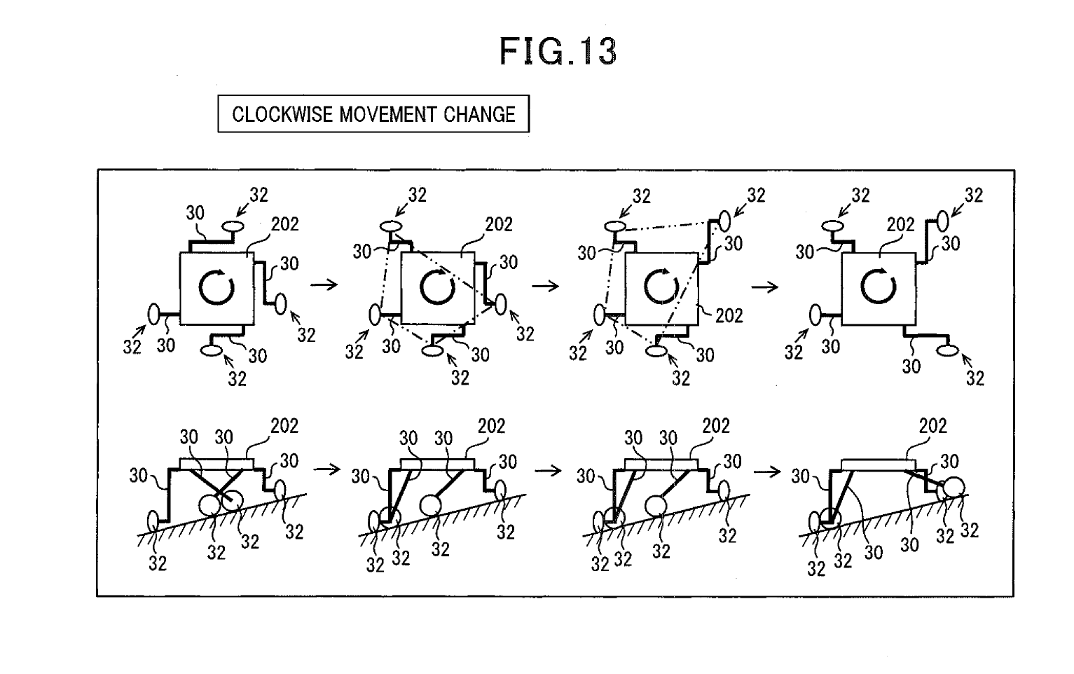

FIG. 13 is a diagram describing changes of the traveling body 201 when turning and moving an inclined floor clockwise.

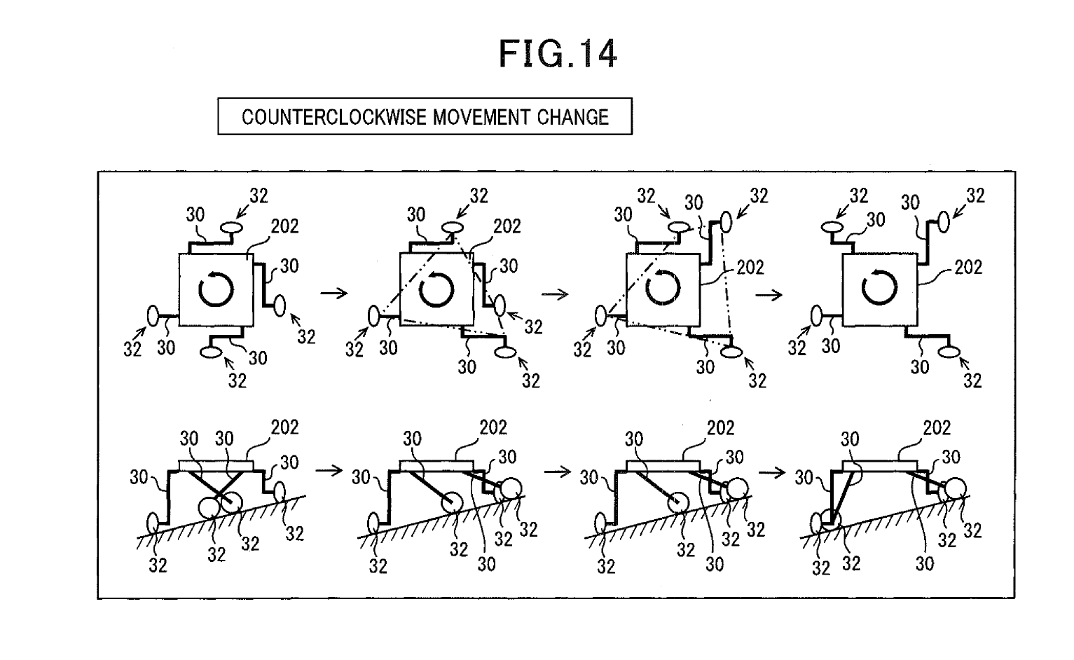

FIG. 14 is a diagram describing changes of the traveling body 201 when turning and moving an inclined floor counterclockwise.

In each drawing, the base part 202 turns rotating by 90 degrees from left to right in arrow directions.

That is, in FIG. 13, by moving from a condition of the left to a condition of the right, each leg 30 is moved to a position displaced angularly clockwise by 90 degrees.

In FIG. 14, by moving from a condition of the left to a condition of the right, each leg 30 is moved to a position displaced angularly counterclockwise by 90 degrees.

The traveling body 201 turns so as to rotate around the base part 202 either turning clockwise or counterclockwise.

Thus, by changing the respective angles of the four legs 30 as shown in the drawings, the traveling body 201 can change the size of the footprint area, which is shown by a two-dot chain line, to be either larger or small without changing the height of the base part 202 much, that is the body height.

### Other Embodiments

Although the preferred embodiments of the present disclosure are described in the embodiments described above, the present disclosure is not limited in any way to the embodiments described above, and may be implemented in various modifications without departing from the scope of the present disclosure.

The structures of the embodiments described above are simply examples, and the scopes of the present disclosure are not intended to be limited to the scopes of the description.

The scopes of the present disclosure are indicated by appended claims, and are intended to include any modifications within the scopes and meanings equivalent to the description of the scopes of the claims.

Although the control unit 50 is configured to be mounted on the traveling body 1 in the embodiment mentioned above, a configuration of the traveling body to which the present disclosure can be applied is not limited.

For example, the control unit 50 may be in a form of being mounted on a controlling device placed outside transmissible with the traveling body 1, a mobile terminal, or the controller 60.

In this case, the movement of the traveling body 1 may be controlled by sending control signals to the actuator 34 for the leg joint or to the wheel motor 35 from the controller 60 or the like.

Although each of the omni wheel 320, the wheel 32, and the leg 30 has the rotating shaft 320a, the rotating shaft 32a, and the joint shaft 30a, respectively, as the objects in the embodiment mentioned above, these shafts may be virtual shafts.

That is, the omni wheel 320, the wheel 32, and the leg 30 rotate in a structure without actual shafts, and an axis of a center of a rotational movement may be present.

Although the traveling body 1, 101 mentioned above has six leg modules 3, the traveling body according to the present disclosure may have a plurality of leg modules 3, and is not limited to this number.

What is claimed is:

1. A traveling body comprising:
a plurality of legs, each of which has a joint shaft and displaces angularly around the joint shaft;
a base part to which the plurality of legs are fixed so as to extend downwardly;
wheels that are respectively disposed at one end of the legs;
a plurality of small rotary members disposed rotatably on an outer periphery of the wheel, the small rotary members constituting parts of the wheel that contact the floor; and
a rotary driving device that changes an angle between the leg and the base part by rotating the joint shaft;
the small rotary member is disposed so that a rotation vector of the small rotary member intersects with both a rotation vector of the wheel and a rotation vector around the joint shaft.

2. The traveling body according to claim 1, wherein,
the rotation vector of the small rotary member intersects perpendicularly with respect to the rotation vector around the joint shaft.

3. The traveling body according to claim 1, wherein,
the rotation vector around the joint shaft is in a direction along the rotation vector of the wheel.

4. The traveling body according to claim 1, wherein,
there is provided a leg module having at least the leg, the wheel, the rotary driving device, and a wheel motor for rotating the wheel; and
the wheel motor is disposed in the leg module so that the leg and a rotation axis of the wheel motor intersect perpendicularly.

5. The traveling body according to claim 4, wherein,
the wheel motor is disposed closer to a center of the base part than the wheel is; and
the rotation axis of the wheel motor and the joint shaft are configured to be substantially coaxial.

6. The traveling body according to claim 1, wherein,
the rotation vector around the joint shaft and the rotation vector of the small rotary member are configured to cross a radius vector extending radially outward from a center of the base part.

7. The traveling body according to claim 4, wherein,
the leg module is disposed on the base part so that the leg and the wheel do not protrude outwardly from an outer peripheral edge of the base part even when the angle between the base part and the leg changes.
